(19) United States
(12) Patent Application Publication
(10) Pub. No.: US 2025/0091170 A1
(43) Pub. Date: Mar. 20, 2025

(54) COOLING MANIFOLD ASSEMBLY

(71) Applicant: rms Company, Coon Rapids, MN (US)

(72) Inventors: Patrick Lee Kellas, Otsego, MN (US); Sean Daniel David Bradshaw, Andover, MN (US); Elijah Thomas Dukart, Oak Grove, MN (US)

(21) Appl. No.: 18/828,135

(22) Filed: Sep. 9, 2024

Related U.S. Application Data
(60) Provisional application No. 63/582,674, filed on Sep. 14, 2023.

(51) Int. Cl. B23Q 11/10

(52) U.S. Cl. CPC B23Q 11/10

(57) ABSTRACT

A cooling manifold assembly configured to deliver cutting fluid includes a manifold body with a coupling for fastening the manifold body to a non-movable portion of a device configured to hold and rotate a workpiece around a central rotational axis of a guide bushing or collet of the device, where the manifold body surrounds at least a portion of the central rotational axis. A first inlet is fluidly coupled to a first channel defined in the manifold body, and a plurality of first outlets of the manifold body are fluidly coupled to the first inlet such that the plurality of first outlets are configured to direct the cutting fluid at a plurality of positions around the central rotational axis at one or a plurality of discharge angles such that the cutting fluid contacts the workpiece and is transmitted away from the guide bushing or collet of the device.

### CROSS-REFERENCE TO RELATED APPLICATION

This application claims priority to U.S. Provisional Patent Application No. 63/582,674, filed Sep. 14, 2023, entitled “COOLING MANIFOLD ASSEMBLY,” which is incorporated by reference herein, in its entirety and for all purposes.

### TECHNICAL FIELD

Provided are cooling manifold assemblies for use in machining applications, and more particularly, the disclosed cooling manifold assemblies deliver cutting fluids during cutting operations.

### BACKGROUND

In machining applications such in CNC (Computer Numerical Control) machining applications, cutting fluid is delivered during cutting operations to cool the cutting area and wash away debris generated by cutting tools. Cutting fluid delivery systems commonly deliver cutting fluid within an enclosure of the CNC machine, such as via flexible coolant pipes, known as gooseneck coolant pipes. Cutting fluid delivery systems integrated into to cutting tools are also known, such as from EP1389504B1.

Such cutting fluid delivery systems may be replaced by or used in connection with the cooling manifold assemblies of the present disclosure.

### SUMMARY

A cooling manifold assembly configured to deliver cutting fluid, according to implementations, may include: a manifold body including a coupling, the coupling configured to fasten the manifold body to a non-movable portion of a device configured to hold and rotate a workpiece around a central rotational axis of a guide bushing or collet of the device, where the manifold body surrounds at least a portion of the central rotational axis; a first inlet fluidly coupled to a first channel defined in the manifold body; a plurality of first outlets of the manifold body, where the first channel is fluidly coupled to the plurality of first outlets, and where the first inlet is configured to receive cutting fluid and the plurality of first outlets are configured to direct the cutting fluid at a plurality of positions around the central rotational axis at one or a plurality of discharge angles such that the cutting fluid contacts the workpiece and is transmitted away from the guide bushing or collet of the device.

According to other implementations, a system may include: a cutting tool within an enclosure; a fluid delivery system; and a cooling manifold assembly in the enclosure configured to deliver cutting fluid from the fluid delivery system to a cutting area. The cooling manifold assembly may include: a manifold body including a coupling, the coupling configured to fasten the manifold body to a non-movable portion of the enclosure at a device configured to hold and rotate a workpiece around a central rotational axis of a guide bushing or collet of the device, where the manifold body surrounds at least a portion of the central rotational axis; a first inlet fluidly coupled to a first channel defined in the manifold body; and a plurality of first outlets of the manifold body, where the first channel is fluidly coupled to the plurality of first outlets, where the first inlet is configured to receive cutting fluid and the plurality of first outlets are configured to direct the cutting fluid at a plurality of positions around the central rotational axis at one or a plurality of discharge angles such that the cutting fluid contacts the workpiece and is transmitted away from the guide bushing or collet of the device.

In various modifications and alternatives, the manifold assembly may additionally include a second inlet fluidly coupled to a second channel defined in the manifold body, the second channel being fluidly isolated from the first channel, the second channel leading to at least one second outlet of the manifold body, where the second inlet is configured to receive pressurized air or cutting fluid, and the at least one second outlet is configured to direct the pressurized air or cutting fluid at a position around the central rotational axis at a discharge angle such that the pressurized air or cutting fluid is transmitted away from the guide bushing or collet of the device. Alternatively, second channel may lead to a second plurality of outlets of the manifold body, where the second inlet is configured to receive pressurized air or cutting fluid, and the second plurality of outlets are configured to direct the pressurized air or cutting fluid at a plurality of positions around the central rotational axis at one or a plurality of discharge angles such that the pressurized air or cutting fluid is transmitted away from the guide bushing or collet of the device.

In various modifications and alternatives, the manifold body may surround at least 1200 of the central rotational axis of the guide bushing or collet of the device, and/or two or more of the first plurality of outlets may be positioned at least 5° apart from one another around the central rotational axis; and/or the first plurality of outlets may define extensions that extend away from a front exterior surface the manifold body, and/or an exterior of the manifold assembly may be configured with a profile that is less than a profile of a cutting tool for cutting the workpiece, and in such cases the coupling may be configured to fasten the manifold body to a housing of the device, the housing defining a compartment in which the workpiece is cut by the cutting tool while being rotated by the guide bushing or collet.

### BRIEF DESCRIPTION OF THE DRAWINGS

FIGS. 1A and 1B illustrate a cooling manifold assembly in a CNC machine tool system, according to certain implementations.

FIG. 2A illustrates a front view of a cooling manifold assembly joined to a lathe, according to certain implementations.

FIG. 2B illustrates a cross-section view of the cooling manifold assembly of FIG. 2A.

FIG. 2C illustrates an isometric view of the cooling manifold assembly joined to the lathe of FIG. 2A.

FIG. 2D illustrates a right side view of the cooling manifold assembly joined to the lathe of FIG. 2A.

FIGS. 2E, 2F and 2G illustrate discharge angles of the outlets of the cooling manifold assembly of FIG. 2A.

FIGS. 3A and 3B illustrate another cooling manifold assembly, according to certain implementations.

FIGS. 4A and 4B illustrate another cooling manifold assembly, according to certain implementations.

FIG. 5 illustrates another cooling manifold assembly, according to certain implementations.

### DETAILED DESCRIPTION

Disclosed are cooling manifold assemblies for delivery of cutting fluids, which are lubricants such as oils or aqueous lubricants, and optionally air, during cutting operations in which a workpiece is cut by a cutting tool. Cutting fluids function to lubricate and cool the workpiece and the cuttng tools, which facilitates cutting and prevents sparks and resulting shop fires. The workpiece may be held by a guide bushing, collet or other workpiece holder, and may be rotated and/or slid back-and-forth during a cutting operation while the cutting tools cut the workpiece. Such cutting operations generate heat and chips from the workpiece, and the cutting fluid delivered from the cooling manifold assemblies of the present disclosure are used in cooling the workpiece and clearing the chips away from the cutting area and the workpiece holder. The cooling manifold assemblies of the present disclosure may be joined to or integrated into a stationary housing of the workpiece holder and at least partially surround a rotational axis of the workpiece holder. Fluid outlets of the cooling manifold assemblies may surround and deliver the cutting fluid at different positions around the rotational axis so as to deliver cutting fluid from multiple outlets to the workpiece being held and rotated around the rotational axis. A discharge angle of the cutting fluid delivered from the fluid outlets may vary among the different fluid outlets so as to deliver the cutting fluid at multiple points along a length of the workpiece, e.g., along the longitudinal axis of the workpiece, which may correspond to the rotational axis of the workpiece holder. During a cutting operation in which a cutting tool cuts the workpiece, operation of the cooling manifold assembly may facilitate ensuring that that cutting fluid from at least one fluid outlet is delivered to the cutting area where the workpiece is cut by the cutting tool, and that chips are cleared away from the cutting area and from the workpiece holder.

The cooling manifold assemblies of the present disclosure are in contrast to cutting fluid delivery components such as flexible goose neck cutting fluid dispensers arranged at various locations in a CNC (Computer Numerical Control) enclosure; are in contrast to coolant systems integrated into the cutting tools themselves; and are in contrast to integrated coolant systems used to cool internal mechanical components such as bearings. Such fluid delivery components and integrated coolant systems may be employed separately and along with the cooling manifold assemblies of the present disclosure, or the presently disclosed cooling manifold assemblies may replace other coolant systems.

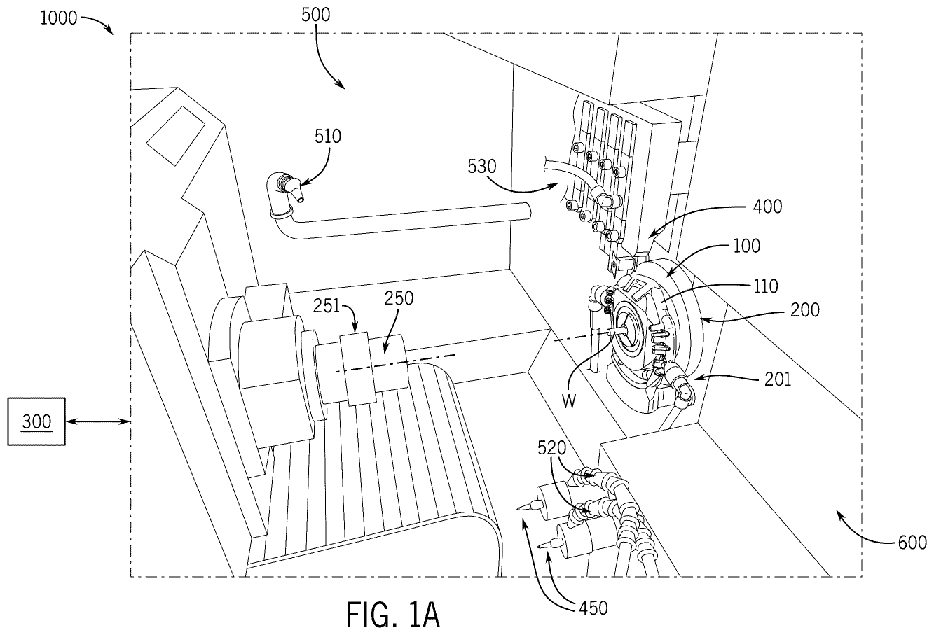

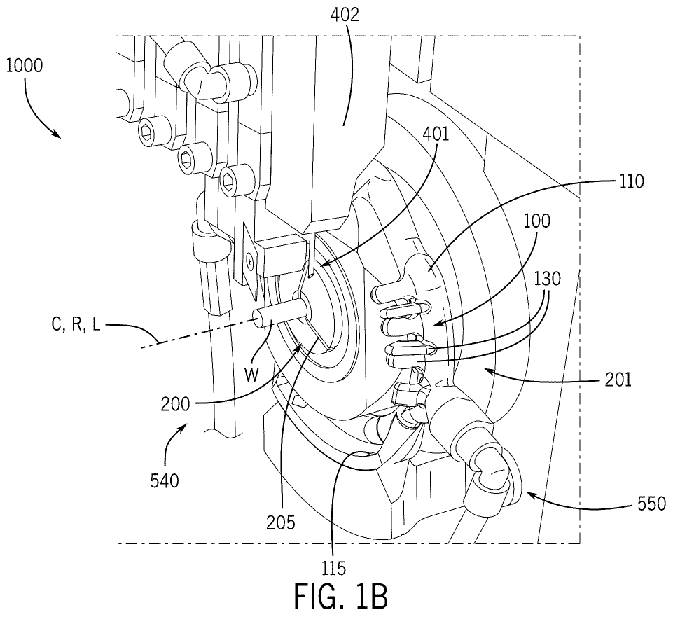

Turning to FIGS. 1A and 1B, illustrated are views of the cooling manifold assembly 100 in a CNC machine tool system 1000, according to certain implementations. The system 1000 may be a CNC Swiss-type lathe, also referred to as a sliding head stock machine, guide bushing machine, or automatic screw machine, sometimes referred to as a cutting machine. A guide bushing 200 of a lathe 201 of the system 1000 may hold a workpiece W and be configured to rotate and slide the workpiece W back-and-forth during a cutting operation. The system 1000 may additionally or alternatively include a collet 250 of a spindle transfer workholding 251, which may be configured to receive a partially finished workpiece W. The workpiece W may be a portion of a raw material such as a metal or extruded article, such as a circular rod, cylindrical rod, square, rectangle, or other polyhedron shape, held by and protruding from a front face of the guide bushing 200 or collet 250.

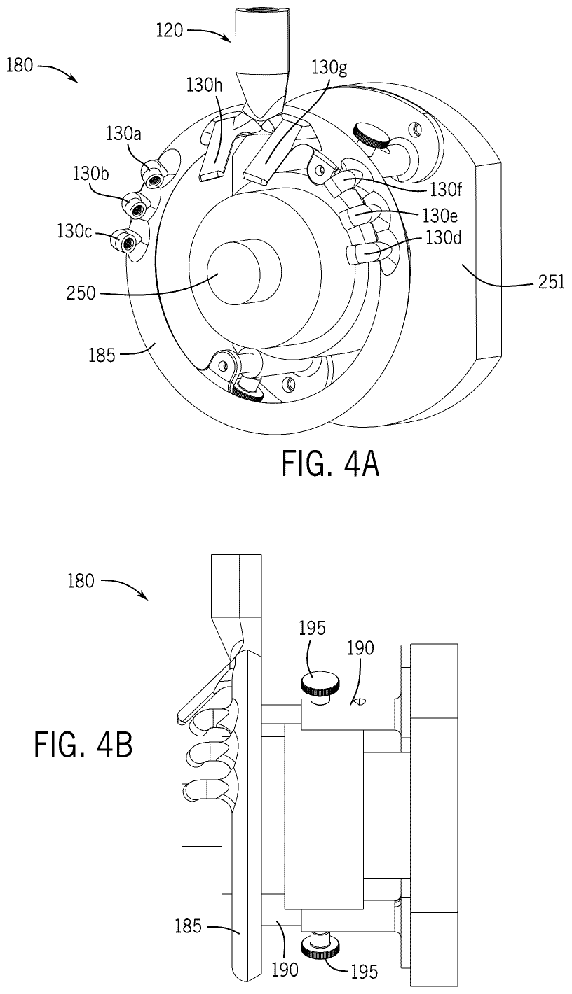

The cooling manifold assembly 100 may surround all or a portion of the guide bushing 200 (e.g., sliding headstock) of the lathe 201, may surround all or a portion of the collet 250 of the spindle transfer workholding 251 (see FIGS. 4A and 4B), or a cooling manifold assembly may be provided at each of the guide bushing 200 and collet 250. Cutting fluid delivered from the cooling manifold assembly 100 may be controlled by a control system 300 of the system 1000, and the control system 300 may additionally control cutting tools 400, 450, a fluid delivery system 500 including additional fluid delivery components 510, 520, 530, and other components of the system 1000. An enclosure 600, such as a CNC enclosure, may house various components of the system 1000.

The cooling manifold assembly 100 or a portion thereof may be positioned relative to the guide bushing 200 or collet 250 to enable the cutting tools 400, 450 to access the workpiece W during the cutting operation. As shown in FIGS. 1A and 1B, a cutting tip 401 attached to a tool holder 402 of the cutting tool 400 may be moved to and operate in cutting the workpiece W held by the guide bushing 200, while the cooling manifold assembly 100 surrounding the guide bushing 200 may deliver cutting fluid to both the workpiece W and cutting tool 400 during cutting. A manifold body 110 of the cooling manifold assembly 100 may thus be positioned and have a shape and profile that enables the tool holder 402 of the cutting tool 400 to be moved proximate the guide bushing 200 and operate the cutting tip 401 in the cutting operation. The manifold body 110 and variants thereof may additionally or alternatively be configured to enable the tools 450 to be moved proximate the collet 250 and operate (see FIGS. 4A and 4B). Outlets 130 of the cooling manifold assembly 100, may be spaced around a radial axis R of the guide bushing 200 and positioned a sufficient distance away therefrom to enable the cutting tip 401 to access and cut the workpiece W held and rotated by the guide bushing 200. The position of the cooling manifold assembly 100 enables the cutting fluid to be delivered from the outlets 130 at an angle, which forces chips from the cut workpiece W away from the guide bushing 200 to help prevent chips from entering one or more radial openings 205 thereof, and prevents from chips wrapping around the workpiece W.

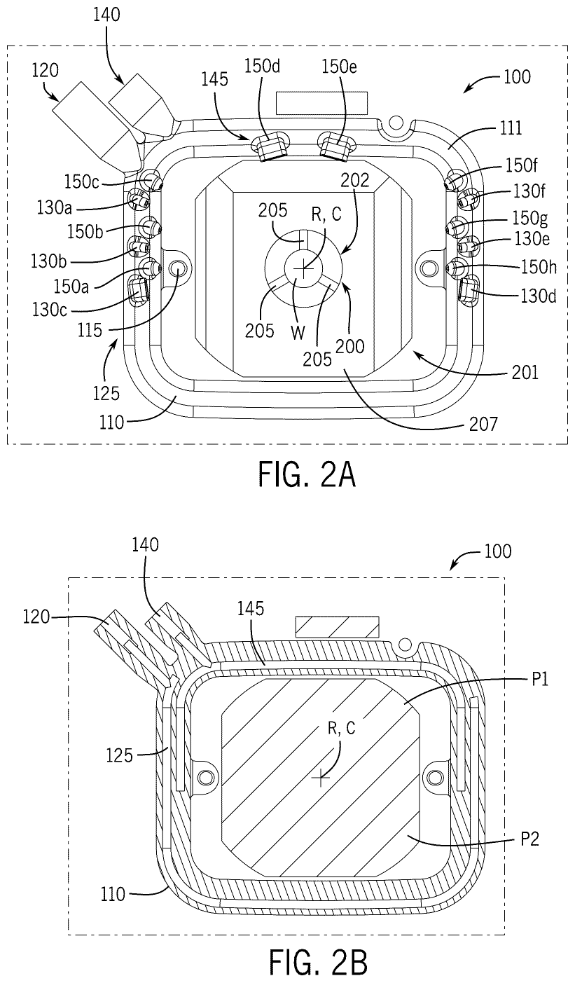

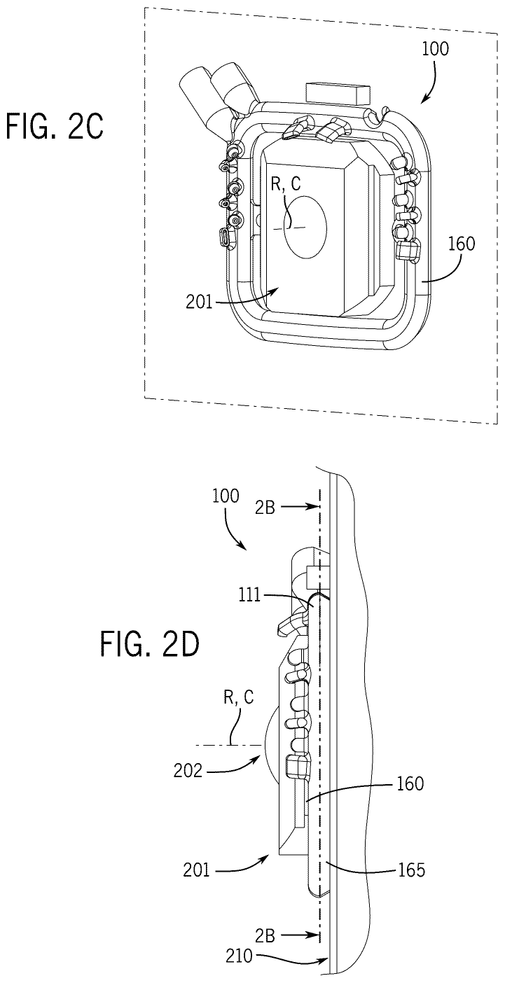

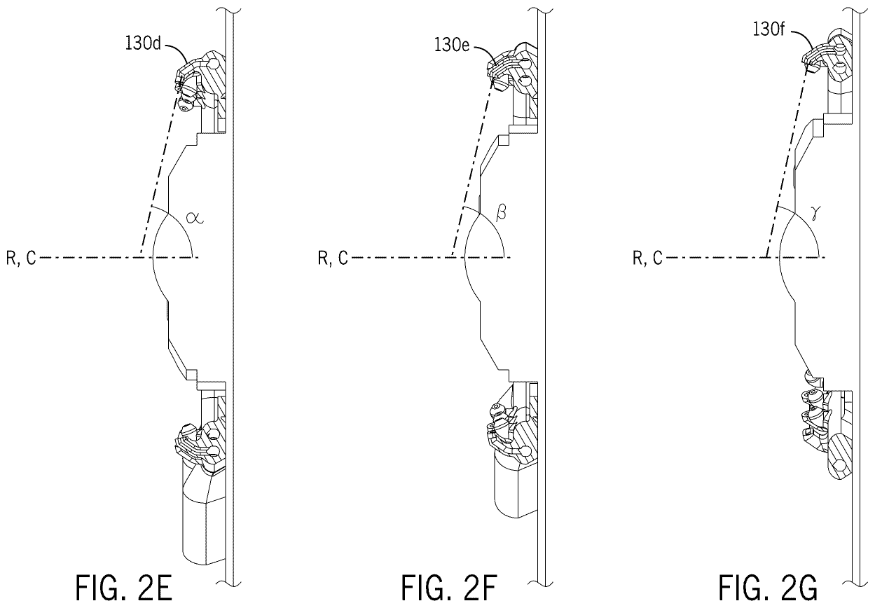

Referring to FIGS. 2A and 2B, the cooling manifold assembly 100 may include a manifold body 110, one or more couplings 115, a first inlet 120, a first fluid channel 125, a first outlet 130a or plurality of first outlets 130a, 130b, 130c, 130d, 130e, 130f, a second inlet 140, a second fluid channel 145, a second outlet 150a or plurality of second outlets 150a, 150b, 150c, 150d, 150e, 150f, 150g, 150h, and a central axis C.

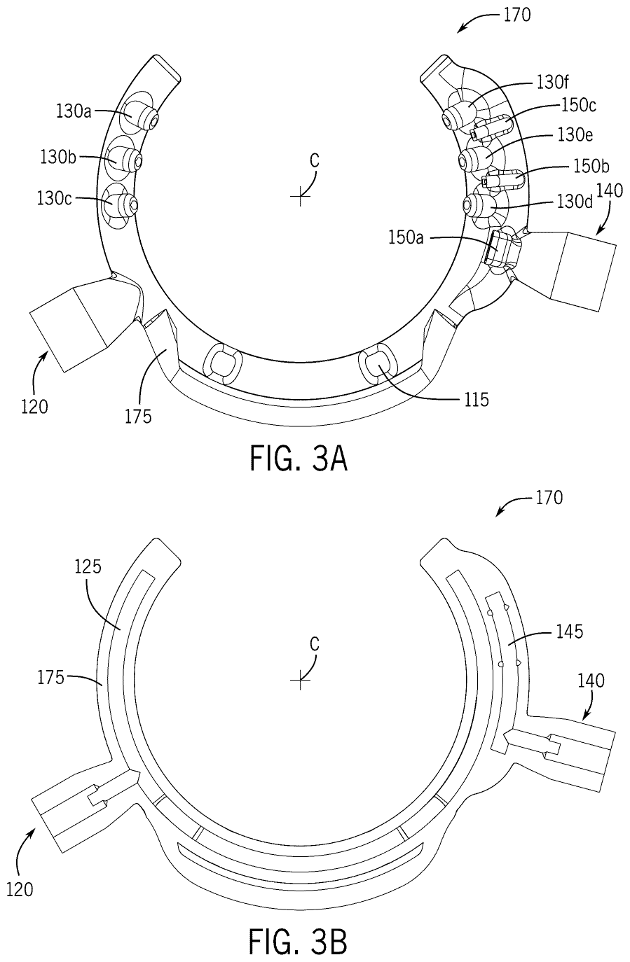

The manifold body 110 may surround at least 1200 of the central rotational axis R of the guide bushing 200 or collet 250. The manifold body 110 may include a central axis C, and the central axis C of the manifold body 110 may be the same as the central rotational axis R of the guide bushing or collet 250 and/or the same as a longitudinal axis L of the workpiece W. In FIGS. 2A and 2B, the manifold body 110 defines a rectangular shape surrounding 360° of the guide bushing 200, with its central axis C being common with the central rotational axis R of the guide bushing 200. In FIGS. 1A and 1B, the manifold body 110 defines a circular or oval shape surrounding 360° of the guide bushing 200, with its central axis C being common with the central rotational axis R of the guide bushing 200. Other manifold body configurations are also possible, such as a square shape, an arc-shape, a U-shape or semi-circular shape for instance as provided in FIGS. 3A and 3B.

The manifold body 110 may be mounted or coupled to a surface of the workpiece holder, e.g., to a surface of the lathe 201 or spindle transfer workholding 251. The body 110 may be arranged perpendicular to the central rotational axis R of the workpiece holder. In alternative configurations, the manifold body 110 may be integrated into a stationary housing portion 207 of the lathe 201 or integrated into a stationary portion of the spindle transfer workholding 251 surrounding the rotatable guide bushing 200 or collet 250. A surrounding portion 111 of the manifold body 110 may be arranged parallel to a front face 202 of the guide bushing 200, and may be positioned at the front face 202, behind or recessed from the front face 202 (FIG. 2D), or slightly in front of the front face 202.

One or more couplings 115 of the manifold body 110 may be configured to fasten, e.g., non-movably join, the manifold assembly 100 to a non-movable portion of the workpiece holder, e.g., to a non-rotatable portion of the lathe 201, spindle transfer workholding 251 or other device configured for holding and rotating the workpiece W around a central rotational axis R. For instance, the one or more couplings 115 may be configured to fasten the manifold body 110 to a non-movable housing portion, and for example, the non-movable housing portion may define a portion of the enclosure 600 in which the workpiece W is cut by the cutting tool 400, 450 while the workpiece W is being rotated and optionally being slid back-and-forth by the guide bushing 200 or collet 250. The one or more couplings 115 may be configured as a through hole, be threaded, and/or may include one or more fasteners such as bolts, screws, rivets, and so on, to enable the manifold body 110 to be non-movably joined to the system 1000 and positioned relative to the workpiece holder, e.g., the guide bushing 200, such that the cutting fluid delivered from the manifold assembly 100 is directed at an angle that forces chips generated during the cutting operation away from both the workpiece W and the workpiece holder to help prevent chips from entering the workpiece holder, e.g., entering unsealed openings of the workpiece holder.

A first inlet 120 of the cooling manifold assembly 100 may be fluidly coupled to a first fluid channel 125 (FIG. 2B) defined in the manifold body 110 and configured to receive cutting fluid. The first channel 125 may lead to a first outlet 130a or plurality of first outlets 130a, 130b, 130c, 130d, 130e, 130f of the manifold body 110. A second inlet 140 of the cooling manifold assembly 100 may be fluidly coupled to a second fluid channel 145 defined in the manifold body 110. The second channel 145 may be fluidly isolated from the first channel 125. The second channel 145 may lead to a second outlet 150a or plurality of second outlets 150a, 150b, 150c, 150d, 150e, 150f, 150g, and 150h of the manifold body 110. The first and second inlets 120, 140 may be configured to receive cutting fluid such as pressurized cutting fluid, pressurized air, or a combination, and transmit the media into the respective first and second channels 125, 145 of the manifold body 110. For instance, the first inlet 120 may be configured to transmit pressurized cutting fluid (e.g., cutting oil), while the second inlet 140 may be configured to transmit pressurized air, or vice versa. The inlets 120, 140 may be integrally formed by the manifold body 110, may be non-detachably joined thereto such as through welding, or may be joined via a threaded connection. The inlets 120, 140 may include fastening structures or fasteners such as threading for coupling to fluid supply lines. For instance, fluid supply lines 540, 550 (FIG. 1B) may deliver fluid from the fluid delivery system 500 to the first and second inlets 120, 140 of the cooling manifold assembly 100.

The first and second fluid channels 125, 145 may separately extend around all or a substantial portion of the circumference of the manifold body 110 and thus together may surround all or a substantial portion of the circumference of the central rotational axis R of the workpiece holder, e.g., at least 360°. This may allow the outlets 130a-130f and 150a-150h to transmit fluid toward the central rotational axis R and at plurality of positions around a circumference of the central rotational axis R. For instance, the each of the first and second channels 125, 145 may surround 300 to 360° of the central rotational axis R. As illustrated in FIG. 2B, the first channel 125 may surround about 260°-280° of the central rotational axis R around a first portion P1 of the guide bushing 200, while the second channel 140 may surround about 170°-190° of the central rotational axis R around a second portion P2 of the guide bushing 200 opposite the first portion. In FIG. 2B, a portion of the second channel 140 spans the portion of the rotational axis R not surrounded by the first channel 125, resulting in the fluid channels 125, 145 surrounding the entire circumference of the manifold body 110 and thus the central rotational axis R and central axis C. In other implementations, the first and second channels 125, 145 may extend around a partial circumference of the central rotational axis R of the workpiece holder. The first and second fluid channels 125, 145 may be integrally formed by the manifold body 110 or may be non-detachably joined thereto such as through welding.

The first outlet 130a or plurality of first outlets 130a, 130b, 130c, 130d, 130e, 130f of the manifold body 110 may be configured to direct the cutting fluid at one or a plurality of positions around the central axis C of the manifold body 110 and the central rotational axis R such that the cutting fluid is transmitted toward the central axis R and angled away from one or more openings of the guide bushing 200 or collet 250 of the respective lathe 201 or spindle transfer workholding 251 from which the workpiece W protrudes, e.g., radial openings 205. The second outlet 150a or plurality of second outlets 150a, 150b, 150c, 150d, 150e, 150f, 150g, 150h of the manifold body 110 may be configured to direct cutting fluid and/or air at one or a plurality of positions around the central axis C of the manifold body 110 and the central rotational axis R such that the cutting fluid and/or air is transmitted toward the central axis R and angled away from such openings. The plurality of first outlets 130a-130f and second outlets 150a-150h of the manifold body 110 may be configured to transmit pressurized cutting fluid (e.g., cutting oil), pressurized air, or a combination. For instance, the first outlet 130a or plurality of first outlets 130a-130f may be configured to transmit pressurized cutting fluid, while the second outlet 150a or plurality of second outlets 150a-150h may be configured to transmit pressurized air.

Referring additionally to FIGS. 2C-2G, in FIGS. 2C and 2D respectively, illustrated are isometric and right side view of the cooling manifold assembly 100 joined to the lathe 200; while FIGS. 2E, 2F and 2G each illustrates different discharge angles of the outlets 130d, 130e, 130f of the cooling manifold assembly 100. The plurality of first and second outlets 130a-130f and 150a-150g may be positioned around and transmit cutting fluid at one or more discharge angles relative to the central axis C of the manifold body 110, which as provided herein, may correspond to the central rotational axis R of the workpiece holder. For instance, the central axis C of the cooling manifold assembly 100 may be a central z-axis of the manifold body 110, while the outlets 130a-130f may be arranged at various positions of the x- and y-axes around the z-axis, and a discharge angle of the outlets discharge cutting fluid along the z-axis. The discharge angle(s) of the outlets 130a-130f and 150a-150g may be selected based on the configuration of the workpiece holder and thus the discharge angles may vary in order for the outlets to deliver the cutting fluid to the workpiece at a non-perpendicular angle and to an area proximate where the workpiece W protrudes from the workpiece holder such that the angle of delivery of the cutting fluid directs chips away from the cut workpiece, away from the cutting tool, and away from the radial openings 205 of the workpiece holder. In some cases, the discharge angle may be 0.5 to 89.5 degrees relative to the central axis C, such as about 1, 2, 3, 4, 5, 6, 7, 8, 9, 10, 15, 20, 25, 30, 35, 40, 45, 50, 55, 60, 65, 70, 75, 80, 85, 86, 87, 88, 89 degrees relative to the central axis C, or about 45 to about 89.5, about 50 to about 89.5, about 50 to about 75, about 60 to about 75, about 60 to about 70 degrees relative to the central axis C. The discharge angle(s) may be oriented away from a front face of the workpiece holder such as away from a front face 202 of the guide bushing 200 and its radial openings 205. This is opposed directing cutting fluid towards the front face 202 and radial openings 205 of the guide bushing 200 in prior approaches. The cooling manifold assembly 100 may therefore wash away chips from the openings 205 and facilitate prevention of the chips from being pushed into such openings 205 during the cutting operation. This may prevent the guide bushing 200 or collet 250 from becoming fouled with chips from the workpiece W. For example, where the manifold body 110 is arranged parallel to and at or slightly recessed from the front face of the workpiece holder, the preferred discharge angle of the outlets 130a-130f and 150a-150g may range from about 50 to about 89, about 60 to about 89, about 70 to about 89, about 80 to about 89 degrees, about 55 to about 75, or about 60 to about 70 degrees relative to the central axis C to achieve the objectives of the present disclosure.

The first outlets 130a-130f and second outlets 150a-150h may be non-movable or non-adjustable relative to the manifold body 110, and for instance may be integrally formed with or fixedly attached thereto, or may be removably attachable to the manifold body such as via a threaded connection. A fluid egress may be defined by the first and second outlets 130a-130f and 150a-150h and may transmit fluid from a respective fluid channel 120, 140 to the exterior of the manifold body 110 and towards the workpiece W. In addition or alternatively, some or all of the first and second outlets may include nozzles fixedly joined thereto and may define the fluid egress. The first and second outlets may accordingly deliver fluid from the respective channels at the discharge angles disclosed herein. The fluid egress may be configured to deliver a stream of fluid, a blade of fluid, or a flat, fan, or cone spray pattern, for instance based on a configuration of a nozzle tip or of the fluid egress.

Each of the plurality of first outlets 130a-130f and/or the plurality of second outlets 150a-150h may be positioned around the central axis C of the manifold body, for instance at least about 5 degrees apart from one another, and up to about 180 degrees apart. For instance, as shown in FIG. 2A, the plurality of first outlets 130a, 130b, 130c are spaced apart from each other by about 15 degrees, whereas the first outlet 130a is spaced apart from the first outlet 130f by about 135 degrees. In some implementations a bank of outlets may oppose or face another bank of outlets. For instance, in FIG. 2A, a bank of first outlets 130a, 130b, 130c may be positioned on one side of the manifold body 110, and another bank of first outlets 130d, 130e, 130f may be positioned on a second side of the manifold body 110 opposite the first side. This may enable the cutting fluid to be delivered from separate sides, e.g., opposing sides, of the manifold body 110. In some implementations, one or more of the plurality of first outlets 130a-130f and one or more of the plurality of second outlets 150a-150f and be interspersed, e.g., alternate relative to each other, and deliver different cutting fluids to the same location or different location around the central axis C. In addition or alternatively, the plurality of first outlets 130a-130f and the plurality of second outlets 150a-150h may be positioned at least about 5 degrees apart from one another around the central rotational axis R, and up to about 180 degrees apart. For instance, as shown in FIG. 2A, the first outlet 130a is spaced apart from the second outlet 150c by about 7 degrees, whereas the first outlet 130c is spaced apart from the second outlet 150h by about 180 degrees.

As more clearly shown in FIGS. 2C and 2D, the first outlets 130a-130f and second outlets 150a-150g may define extensions that extend away from a front exterior surface 160 the manifold body 110, while a back exterior surface 165 of the manifold body 110 may be configured to be received by a complementary surface 210 of the stationary or non-movable portion of the workpiece holder. For instance, the back exterior surface 165 include a substantially planar, flat surface when the complementary surface 210 is a flat wall extending perpendicular to the central rotational axis R of the workpiece holder. In addition or alternatively, the back exterior surface 165 and the coupling 115 of the manifold body 110 may be configured to mount to the workpiece holder such that the central axis C of the manifold body 110 aligns with the central rotational axis R of the workpiece holder, for instance as shown in FIG. 2A.

As more clearly shown in FIG. 1B, the cooling manifold assembly 100 may be configured with a profile that when joined to the workpiece holder is less than a profile of a cutting tool of a cutting tool system. In FIG. 1B, the cooling manifold assembly 100 is coupled to the lathe 201 so that it is recessed from the guide bushing 200. The plurality of first and second outlets (e.g., 130a-130f and 150a-150g) project from the manifold body 110 and the egresses of the outlets may be configured to deliver the cutting fluid to the central rotational axis R of the guide bushing 200 at a discharge angle that results in the cutting fluid being delivered to the cutting area of the cutting tip 401 of the cutting tool 400 during cutting of the workpiece W as well as along the length of the workpiece. In FIG. 1B, because the fluid egresses are also recessed from the guide bushing 200, the fluid is discharged such that the fluid forces chips away from the front face 202 of the guide bushing 200 and towards a basin of the interior of the chamber 600 where the chips may be collected with the cutting fluid.

FIGS. 2E, 2F and 2G illustrate different discharge angles of the outlets 130d, 130e, 130f of the cooling manifold assembly 100, according to the present disclosure. In FIG. 2E, the outlet 130d delivers fluid at discharge angle α, while in FIG. 2F, the outlet 130e delivers fluid at discharge angle β, and in FIG. 2G, the outlet 130f delivers fluid at discharge angle γ, to the common axes C, R. The discharge angles α, β, and γ, may be the same or may differ from each other such that fluid is delivered from the outlets 130d, 130e, 130f at the same or different locations in the area proximate the cutting area of the workpiece W. For instance, the fluid may be delivered in the direction of the central axis C of the cooling manifold assembly 100 at different locations along the length of the workpiece W, e.g., along the longitudinal axis of the workpiece W, as provided herein. It will be appreciated that the discharge angles α, β, and γ may include various angles such as the discharge angles relative to the central axis C disclosed herein, or an angle of another axis in common with the central axis C, e.g., rotational axis R or longitudinal axis L.

FIGS. 3A and 3B illustrate a cooling manifold assembly 170 with a manifold body 175 that differs from the manifold body 110 of the cooling manifold assembly 100 of FIGS. 1A-2G in that the manifold body 175 surrounds about 290° of a circumference of the central axis C of the manifold body 175 in a semi-circle shape, whereas the manifold bodies 110 of FIGS. 1A-2G surround the entire circumference of the central axis C. The cooling manifold assembly 170 may include elements that have been previously described with respect to the cooling manifold assembly 100 of FIGS. 1A-2G. Those elements have been identified in FIGS. 3A and 3B using the same reference numbers used in FIGS. 1A-2G and operation of the common elements is as previously described. Consequently, a detailed description of the operation of these particular elements will not be repeated in the interest of brevity.

In FIG. 3B, the first channel 125 defines a semi-circle shape spanning nearly the entire circumference of the manifold body 175 and the plurality of first outlets 130a-130f are directed towards the central axis C on two sides, while the plurality of second outlets 150a-150c are directed towards the central axis C on one side, e.g., the same side as the plurality of first outlets 130d-130f. The configuration of the cooling manifold assemblies 100, 170 may thus be customized for instance to ensure that the cutting fluid is delivered to the cutting area for instance from both sides, e.g., from first outlets 130a-130f, and the ability to position second outlets on a single side of the manifold, which may enable the cooling manifold assembly 170 to deliver compressed air from a single side. The manifold body 175 may define a protrusion in the area of the one or more couplings 115, which may facilitate joining the cooling manifold assembly 170 to the lathe 201 or the spindle transfer workholding 251 in an area surrounding the central rotational axis R of the guide bushing 200 or collet 250 (see e.g., the coupling 115 of FIG. 1B).

FIGS. 4A and 4B illustrate a cooling manifold assembly 180 with a manifold body 185 that differs from the manifold body 110 of the cooling manifold assembly 100 of FIGS. 1A-2G in that the manifold body 185 may be adjustably positionable relative to the spindle transfer workholding 251, which is illustrated in connection with a collet 250. The cooling manifold assembly 180 may include elements that have been previously described with respect to the cooling manifold assembly 100 of FIGS. 1A-2G. Those elements have been identified in FIGS. 4A and 4B using the same reference numbers used in FIGS. 1A-2G and operation of the common elements is as previously described. Consequently, a detailed description of the operation of these particular elements will not be repeated in the interest of brevity.

As best shown in FIG. 4B, the manifold body 185 may include support legs 190 with an adjustable length. For instance, the support legs 190 may include two or more leg components, which may be telescopic. The support legs 190 may be locked into a fixed position using a locking mechanism 195, such as a friction lock or locking detent mechanism. The adjustability of the position of the cooling manifold assembly 185 with respect to the collet 250 enables the cutting fluid to be delivered from its plurality of outlets at an angle, which forces chips from the cut workpiece W away from the collet 250 to help prevent chips from entering openings in the collet, e.g., similar to openings 205 of the guide bushing 200. The manifold body 185 may include a single first inlet 120, which may fluidly couple to the plurality of first outlets, such as the plurality of first outlets 130a-130h via a fluid channel as provided herein. However, the manifold body 185 may include two inlets 120, 140 and corresponding fluid channels 125, 145 as described herein.

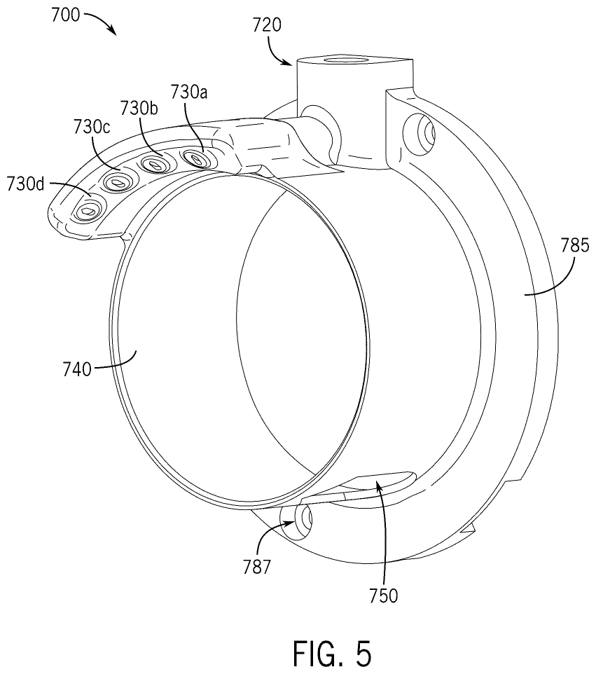

FIG. 5 illustrates a cooling manifold assembly 700 with a manifold body 785 that differs from the manifold body 185 of the cooling manifold assembly 180 of FIGS. 4A-4B in that the manifold body 785 may be non-adjustable relative to a workpiece holder, e.g., the collet 250, but otherwise operates in a similar manner. The cooling manifold assembly 700 may include elements that have been previously described with respect to the cooling manifold assembly 180 of FIGS. 4A-4B. Those elements use different reference numbers, but have similar functions. Consequently, a detailed description of the operation of these particular elements will not be repeated in the interest of brevity, but will reference the corresponding elements of FIGS. 4A-4B.

The manifold body 785 may be coupled to the collet 250 or other workpiece holder. The manifold body 785 may be coupled to the collet 250 via one or more fasteners 787. A sleeve 740 may extend from the manifold body 785, such as towards a distal end of the transfer workholding 251. A distance the sleeve 740 extends from the manifold body 785 may depend on a distance to the distal end of the collet 250, and for instance, the sleeve may be recessed from the distal end of the collet 250. The sleeve 740 may include an aperture 750. The aperture 750 may provide clearance to allow the manifold assembly 700 to be mounted to the collet 250 by the machine. The aperture 750 may aid in draining oil from the manifold body 785. The aperture 750 may permit shavings to be removed from the manifold assembly 700.

The manifold assembly 700 may include an inlet 720. The inlet 720 may fluidly couple to a plurality of outlets 730a-730d. The plurality of outlets 730a-730d may be positioned along an edge of the sleeve 740. Each of the plurality of outlets 730a-730d may have a unique angle. Cutting fluid may be delivered from the plurality of outlets 730a-730d to force chips away from the cut workpiece W away from the collet 250 to help prevent chips from entering openings in the collet 250. The fluid may clean and cool pieces while cutting. By providing the plurality of outlets 730a-730d at different angles, the chance of clogging may be reduced. The plurality of outlets 730a-730d may be positioned to enable the tools 450 to be moved proximate the collet 250 and operate as provided hereinabove in connection with the manifold assemblies of the present disclosure.

In operation, the cooling manifold assemblies 100, 170, 180, 700 may deliver cutting fluid, e.g., a compressed cutting fluid, a compressed gas such as air, or combinations. For ease of reference, the operation of the cooling manifold assembly 100 is referred to herein, but such operation also applies to the cooling manifold assemblies 170, 180, 700. The cutting fluid may be delivered during a cutting operation, which may involve a time frame prior to, during, and/or after the cutting tools 400, 450 operate. As the workpiece W is held by the guide bushing 200 or collet 250 and optionally rotated and slid back-and-forth, the one or more cutting tools 400, 450 operate to cut the workpiece W generating heat, possibly sparks, and chips from the cut workpiece W, and the cutting fluid from the cooling manifold assembly 100 cools the cutting area and washes the chips away.

In some implementations, the cooling manifold assembly 100 surrounds at least a portion of a guide bushing 200 or collet 250 delivers cutting fluid at multiple points around an orifice of the guide bushing support where the workpiece W protrudes and is optionally rotated and moved back-and-forth during the cutting operation. The cutting fluid may be delivered to the workpiece W at a discharge angle relative to the central axis C and longitudinal axis L workpiece, and the outlets of the manifold body 110, e.g., one or more of the outlets 130a-130f and 150a-150g, may have differing discharge angles resulting in the cutting fluid being delivered along various positions of the workpiece W, such as along the longitudinal axis or length of the workpiece W. As a result of the fluid and/or air delivery from the cooling manifold assembly 100, the chips cut from the workpiece W are washed away from the guide bushing 200 or collet 250, e.g., washed away from a front face thereof, and prevent the chips from entering and fouling equipment, especially from any unsealed portions of the guide bushing and spindle transfer workholding. As illustrated throughout the figures, the cooling manifold assembly 100 may include one or more outlets that direct cutting fluid at various downward angles, e.g., outlets 130a, 130f, 150c, 150d, 150e, so that the fluid delivered therefrom is assisted by gravity when carried to the workpiece W and then into the system 1000, while other outlets may direct the cutting fluid in a sideways or upwardly angled manner, e.g., outlets 150a, 150h, 130c, 130d, such that the cutting fluid is delivered to the workpiece W by the pressure of the pressurized cutting fluid and then gravity carries the cutting fluid into the system 1000.

In some implementations, the control system 300 may control delivery of cutting fluid to the cooling manifold assembly 100. For instance, the control system 300 may include one or more processors and memory and be programmed with instructions to control the cutting tools 400, 450, and the fluid delivery system 500. In examples, the control system 300 may be a CNC control system. For instance, a user of the system 1000 may monitor operation of the cooling manifold assembly 100, the guide bushing 200, collet 250, the cutting tools 400, 450, and so on, and may provide input such as instructions for conducting the cutting operation using the control system 300. The workpiece W machined during the cutting operations may include a variety of cuts such as precision cuts. For instance, a first set of precision cuts may be conducted on the workpiece as it is held, rotated and optionally slid back-and-forth by the guide bushing 200 and cut by a first set of cutting tools, e.g., cutting tools 400. The cut, partially finished workpiece W may be transferred, e.g., cut apart from the raw material and transferred, to the collet 250. The transferred workpiece W may be held, rotated and optionally slid back-and-forth by the collet 250 and may be cut by a second set of cutting tools, e.g., cutting tools 450. Accordingly, cooling manifold assemblies may be provided at and surround each of the guide bushing 200 and the collet 250. For instance, the cooling manifold assembly 100 or 170 may surround the guide bushing 200; while the cooling manifold assembly 180 or 700 may surround the collet 250 for delivery of cutting fluid from both cooling manifold assemblies during operation of the system 1000. After cutting, the finished workpiece W may be released by the guide bushing 200 or the collet 250 and collected from the system 1000.

The cutting tools 400, 450 may include drive units (e.g., motors, actuators, etc.) for rotating and/or positioning the cutting tools 400, 450 relative to a workpiece W situated within the enclosure 600. For example, the cutting tools 400, 450 may be positioned relative to the workpiece W while the workpiece W is rotated and/or slid back-and-forth relative to a cutting tool, which removes material from the rotating workpiece W. Alternatively or additionally, the cutting tool may be rotated while the workpiece W is held stationary by the guide bushing 200 or collet 250 and the rotating cutting tool may remove material from the workpiece W.

The cutting fluid may be supplied to the cooling manifold assembly 100 from the fluid delivery system 500, and the system 500 may optionally deliver cutting fluid to additional fluid delivery components 510, 520, 530 for instance to facilitate cooling and chip clearing operations in other areas of the system 1000. The fluid delivery system 500 may include one or more vessels for storing cutting fluid, one or more pumps for delivering the stored cutting fluid to the cooling manifold assembly 100, e.g., via fluid supply lines 540, 550 (FIG. 1B). The fluid delivery system 500 may optionally be configured to collect, filter, and recirculate the cutting fluid emitted during the cutting operations.

The enclosure 600 may provide an enclosed area in which the manifold assemblies 100, the guide bushing 200, collet 250, the cutting tools 400, 450, and so on, operate. The enclosure 600 may protect the workpiece W from the external environment, and may protect the user from the cutting fluid and chips cut from the workpiece W during operation of the system. The enclosure may accordingly include one or more sealable openings, e.g., slidable doors or drawers, to provide access to the enclosure for instance to collect finished workpieces and/or access the aforementioned internal components of the system 1000.

The CNC machine tool of the system 1000 described herein is of an example CNC machine tool, and implementations are not limited to the type of CNC machine tool depicted in the figures and may be incorporated into other types or configurations of machine tools that may include different combinations and/or arrangements of components.

Various changes may be made in the form, construction and arrangement of the components of the present disclosure without departing from the disclosed subject matter or without sacrificing all of its material advantages. The form described is merely explanatory, and it is the intention of the following claims to encompass and include such changes. Moreover, while the present disclosure has been described with reference to various embodiments, it will be understood that these embodiments are illustrative and that the scope of the disclosure is not limited to them. Many variations, modifications, additions, and improvements are possible. Functionality may be separated or combined in blocks differently in various embodiments of the disclosure or described with different terminology. These and other variations, modifications, additions, and improvements may fall within the scope of the disclosure as defined in the claims that follow.

What is claimed is:

1. A cooling manifold assembly configured to deliver cutting fluid, comprising:
a manifold body comprising a coupling, the coupling configured to fasten the manifold body to a non-movable portion of a device configured to hold and rotate a workpiece around a central rotational axis of a guide bushing or collet of the device, wherein the manifold body surrounds at least a portion of the central rotational axis;
a first inlet fluidly coupled to a first channel defined in the manifold body; and
a plurality of first outlets of the manifold body, wherein the first channel is fluidly coupled to the plurality of first outlets,
wherein the first inlet is configured to receive cutting fluid and the plurality of first outlets are configured to direct the cutting fluid at a plurality of positions around the central rotational axis at one or a plurality of discharge angles such that the cutting fluid contacts the workpiece and is transmitted away from the guide bushing or collet of the device.

2. The manifold assembly of claim 1, further comprising a second inlet fluidly coupled to a second channel defined in the manifold body, the second channel being fluidly isolated from the first channel, the second channel leading to at least one second outlet of the manifold body, wherein the second inlet is configured to receive pressurized air or cutting fluid, and the at least one second outlet is configured to direct the pressurized air or cutting fluid at a position around the central rotational axis at a discharge angle such that the pressurized air or cutting fluid is transmitted away from the guide bushing or collet of the device.

3. The manifold assembly of claim 1, further comprising a second inlet fluidly coupled to a second channel defined in the manifold body, the second channel being fluidly isolated from the first channel, the second channel leading to a second plurality of outlets of the manifold body, wherein the second inlet is configured to receive pressurized air or cutting fluid, and the second plurality of outlets are configured to direct the pressurized air or cutting fluid at a plurality of positions around the central rotational axis at one or a plurality of discharge angles such that the pressurized air or cutting fluid is transmitted away from the guide bushing or collet of the device.

4. The manifold assembly of claim 1, wherein the manifold body surrounds at least 120° of the central rotational axis of the guide bushing or collet of the device.

5. The manifold assembly of claim 1, wherein two or more of the first plurality of outlets are positioned at least 5° apart from one another around the central rotational axis.

6. The manifold assembly of claim 1, wherein the first plurality of outlets define extensions that extend away from a front exterior surface the manifold body.

7. The manifold assembly of claim 1, wherein an exterior of the manifold assembly is configured with a profile that is less than a profile of a cutting tool for cutting the workpiece.

8. The manifold assembly of claim 7, wherein the coupling is configured to fasten the manifold body to a housing of the device, the housing defining a compartment in which the workpiece is cut by the cutting tool while being rotated by the guide bushing or collet.

9. A system, comprising:
a cutting tool within an enclosure;
a fluid delivery system; and
a cooling manifold assembly in the enclosure configured to deliver cutting fluid from the fluid delivery system to a cutting area, the cooling manifold assembly comprising:
a manifold body comprising a coupling, the coupling configured to fasten the manifold body to a non-movable portion of the enclosure at a device configured to hold and rotate a workpiece around a central rotational axis of a guide bushing or collet of the device, wherein the manifold body surrounds at least a portion of the central rotational axis;
a first inlet fluidly coupled to a first channel defined in the manifold body; and
a plurality of first outlets of the manifold body, wherein the first channel is fluidly coupled to the plurality of first outlets,
wherein the first inlet is configured to receive cutting fluid and the plurality of first outlets are configured to direct the cutting fluid at a plurality of positions around the central rotational axis at one or a plurality of discharge angles such that the cutting fluid contacts the workpiece and is transmitted away from the guide bushing or collet of the device.

10. The system of claim 9, the cooling manifold assembly further comprising a second inlet fluidly coupled to a second channel defined in the manifold body, the second channel being fluidly isolated from the first channel, the second channel leading to at least one second outlet of the manifold body, wherein the second inlet is configured to receive pressurized air or cutting fluid, and the at least one second outlet is configured to direct the pressurized air or cutting fluid at a position around the central rotational axis at a discharge angle such that the pressurized air or cutting fluid is transmitted away from the guide bushing or collet of the device.

11. The system of claim 9, the cooling manifold assembly further comprising a second inlet fluidly coupled to a second channel defined in the manifold body, the second channel being fluidly isolated from the first channel, the second channel leading to a second plurality of outlets of the manifold body, wherein the second inlet is configured to receive pressurized air or cutting fluid, and the second plurality of outlets are configured to direct the pressurized air or cutting fluid at a plurality of positions around the central rotational axis at one or a plurality of discharge angles such that the pressurized air or cutting fluid is transmitted away from the guide bushing or collet of the device.

12. The system of claim 9, wherein the manifold body surrounds at least 120° of the central rotational axis of the guide bushing or collet of the device.

13. The system of claim 9, wherein two or more of the first plurality of outlets are positioned at least 5° apart from one another around the central rotational axis.

14. The system of claim 9, wherein the first plurality of outlets define extensions that extend away from a front exterior surface the manifold body.

15. The system of claim 9, wherein an exterior of the manifold assembly is configured with a profile that is less than a profile of the cutting tool for cutting the workpiece.

16. The system of claim 15, wherein the coupling is configured to fasten the manifold body to a housing of the device, the housing defining a compartment in which the workpiece is cut by the cutting tool while being rotated by the guide bushing or collet.
